(19) United States
(12) Patent Application Publication
(10) Pub. No.: US 2025/0235793 A1
(43) Pub. Date: Jul. 24, 2025

(54) METHOD, COMPUTER PROGRAM AND APPARATUS FOR TRAINING AN AUTONOMOUS AGENT

(71) Applicant: Sony Interactive Entertainment Inc., Tokyo (JP)

(72) Inventors: Timothy Edward Bradley, London (GB); Ayush Raina, San Mateo, CA (US); Ryan John Spick, London (GB); Pierluigi Vito Amadori, London (GB); Guy David Moss, London (GB)

(73) Assignee: Sony Interactive Entertainment Inc., Tokyo (JP)

(21) Appl. No.: 19/008,339

(22) Filed: Jan. 2, 2025

(30) Foreign Application Priority Data
Jan. 18, 2024 (GB) 2400678.5

(51) Int. Cl. A63F 13/67; G06N 3/0475; G06N 3/092

(52) U.S. Cl. CPC A63F 13/67; G06N 3/0475; G06N 3/092

(57) ABSTRACT

A method of training an autonomous agent is provided, the method comprising: providing videogame data generated by a human playing a videogame as input data to a training network for training an autonomous agent for playing the videogame; generating videogame data of the trained autonomous agent playing the videogame; providing the videogame data of the trained autonomous agent playing the videogame data to a discriminator of a generative adversarial network ‘GAN’, the discriminator of the GAN being trained to distinguish videogame data of a human playing the videogame and videogame data of an autonomous agent playing the videogame; generating a classification, by the discriminator of the GAN, of the output videogame data of the trained autonomous agent playing the videogame as human or agent; and updating at least one of the training network and the discriminator of the GAN based on the classification generated by the discriminator of the GAN.

### BACKGROUND

### Field of the Disclosure

The present disclosure relates to a method, computer program and apparatus for training an autonomous agent.

### Description of the Related Art

The “background” description provided herein is for the purpose of generally presenting the context of the disclosure. Work of the presently named inventors, to the extent it is described in the background section, as well as aspects of the description which may not otherwise qualify as prior art at the time of filing, are neither expressly nor impliedly admitted as prior art against the present invention.

Software, such as videogames, typically require a user to perform a certain action or control as an input. The software then takes this input and performs certain processing operations in response to the input. The software then produces an output as a result of the processing which has been performed.

Taking videogames as an example, a user may provide one or more inputs to control a character within a videogame environment. Such inputs may be provided using one or more controller devices (e.g. handheld controllers) and/or other similar peripheral devices. Processing may then be performed in response to the input to control the character.

For example, one or more updates to a location of the character within the videogame environment may be achieved in response to the input. Alternatively or in addition, one or more limbs (e.g. arms) of a character may be controlled. In some video games, a user may control another entity such as a virtual car, and user inputs may relate to steering input for a virtual vehicle, for example. Hence more generally, a game state of the video game can be updated in response to one or more user inputs and one or more output video images can be generated for providing a visual indication of the video game being progressed by the user.

However, it is often desired that software which has been produced to be controlled by a user (i.e. software which requires input instructions from a user) is operated independently from human instruction. That is, autonomous operation of the software is often desired.

To this end, an autonomous agent may be trained in order to control the software. For example, an autonomous agent may be trained on the basis of maximizing their performance in a videogame.

Previous techniques have sought to train agents for playing video games with the aim of maximizing performance and developing advanced skills that can potentially rival and in some cases surpass those of professional gamers. However, such agents typically exhibit behaviors and traits that differ from those expected for human players. For example, occurrences of non-human like behavior by such agents during a video game can potentially lead to a loss of immersion for a player. Therefore, potential uses of autonomous agents may be restricted.

It is an aim of the present disclosure to address these issues.

### SUMMARY

A brief summary about the present disclosure is provided hereinafter to provide a basic understanding related to certain aspects of the present disclosure.

Embodiments of the present disclosure are defined by the independent claims. Further aspects of the disclosure are defined by the dependent claims.

In accordance with embodiments of the disclosure an autonomous agent (such as an autonomous agent for playing a videogame) can be trained more easily and efficiently to act in a manner which conveys human-like behavior.

The present disclosure is not particularly limited to this advantageous technical effect. Other technical effects will become apparent for the skilled person when reading the disclosure.

### BRIEF DESCRIPTION OF THE DRAWINGS

A more complete appreciation of the disclosure and many of the attendant advantages thereof will be readily obtained as the same becomes better understood by reference to the following detailed description when considered in connection with the accompanying drawings, wherein:

FIG. 1 illustrates an apparatus in accordance with embodiments of the disclosure;

FIG. 2 illustrates an entertainment system in accordance with embodiments of the disclosure;

FIG. 3 illustrates an apparatus in accordance with embodiments of the disclosure;

FIG. 4 illustrates an example of a generative network in accordance with embodiments of the disclosure;

FIG. 5 illustrates an example of a discriminator in accordance with embodiments of the disclosure;

FIG. 6 illustrates an example implementation of an apparatus in accordance with embodiments of the disclosure;

FIG. 7 illustrates an example of a training network in accordance with embodiments of the disclosure; and

FIG. 8 illustrates a method in accordance with embodiments of the disclosure.

### DESCRIPTION OF THE EMBODIMENTS

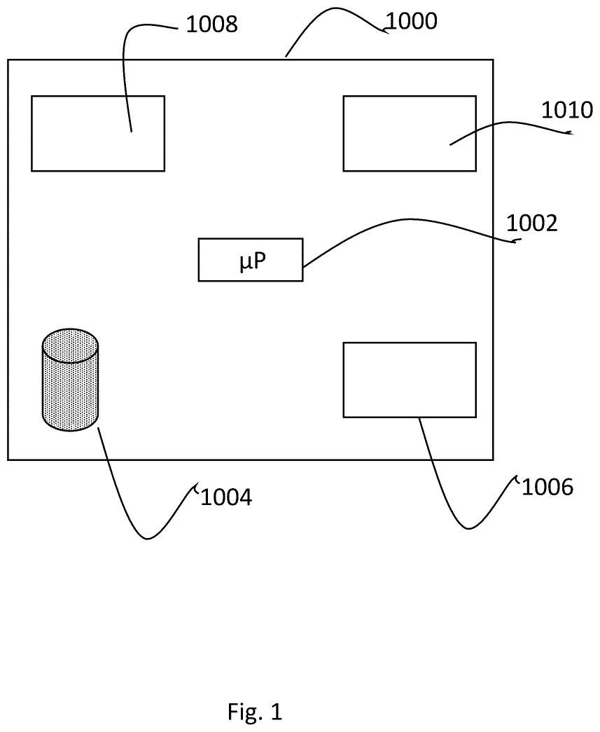

Referring to FIG. 1, an apparatus 1000 (an example of an information processing device) according to embodiments of the disclosure is shown. Typically, an apparatus 1000 according to embodiments of the disclosure is a computer device such as a personal computer, an entertainment system or video game console, or a terminal connected to a server. Indeed, in embodiments, the apparatus may also be a server. The apparatus 1000 is controlled using a microprocessor or other processing circuitry 1002. In some examples, the apparatus 1000 may be a portable computing device such as a mobile phone, laptop computer or tablet-computing device.

The processing circuitry 1002 may be a microprocessor carrying out computer instructions or may be an Application Specific Integrated Circuit. The computer instructions are stored on storage medium 1004 which maybe a magnetically readable medium, optically readable medium or solid-state type circuitry. The storage medium 1004 may be integrated into the apparatus 1000 or may be separate to the apparatus 1000 and connected thereto using either a wired or wireless connection. The computer instructions may be embodied as computer software that contains computer readable code which, when loaded onto the processor circuitry 1002, configures the processor circuitry 1002 to perform a method according to embodiments of the disclosure.

Additionally, an optional user input device 1006 is shown connected to the processing circuitry 1002. The user input device 1006 may be a touch screen or may be a mouse or stylist type input device. The user input device 1006 may also be a keyboard, controller, or any combination of these devices. In some examples, the user input device 1006 may be a microphone or other device. The user to may then provide input via sounds or speech.

A network connection 1008 may optionally be coupled to the processor circuitry 1002. The network connection 1008 may be a connection to a Local Area Network or a Wide Area Network such as the Internet or a Virtual Private Network or the like. The network connection 1008 may be connected to a server allowing the processor circuitry 1002 to communicate with another apparatus in order to obtain or provide relevant data. The network connection 1002 may be behind a firewall or some other form of network security.

Additionally, shown coupled to the processing circuitry 1002, is a display device 1010. The display device 1010, although shown integrated into the apparatus 1000, may additionally be separate to the apparatus 1000 and may be a monitor or some kind of device allowing the user to visualize the operation of the system (e.g. a display screen or a head mounted display). In addition, the display device 1010 may be a printer, projector or some other device allowing relevant information generated by the apparatus 1000 to be viewed by the user or by a third party.

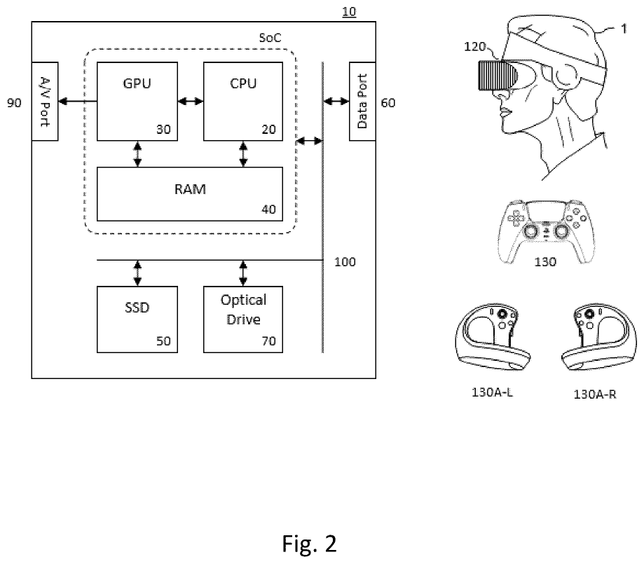

Consider, now, FIG. 2 of the present disclosure. FIG. 2 illustrates an example of an entertainment system.

The entertainment system 10 is a computer or console.

The entertainment system 10 comprises a central processor or CPU 20. The entertainment system also comprises a graphical processing unit or GPU 30, and RAM 40. Two or more of the CPU, GPU, and RAM may be integrated as a system on a chip (SoC).

Further storage may be provided by a disk 50, either as an external or internal hard drive, or as an external solid-state drive, or an internal solid-state drive.

The entertainment device may transmit or receive data via one or more data ports 60, such as a USB port, Ethernet® port, Wi-Fi® port, Bluetooth® port or similar, as appropriate. It may also optionally receive data via an optical drive 70.

Audio/visual outputs from the entertainment device are typically provided through one or more A/V ports 90 or one or more of the data ports 60.

Where components are not integrated, they may be connected as appropriate either by a dedicated data link or via a bus 100.

An example of a device for displaying images output by the entertainment system is a head mounted display ‘HMD’ 120, worn by a user 1.

Interaction with the system is typically provided using one or more handheld controllers 130, and/or one or more VR controllers (130A-L,R) in the case of the HMD.

Software (such as a videogame) often requires human input. For example, a user playing a videogame must typically provide input instructions when playing the videogame. These input instructions may relate to control of a character within the videogame, for example. As explained in the Background, it is often desired that an autonomous agent is provided which can perform some or all of the actions which need to be performed by a human. For example, it may be desired that an autonomous agent performs controls to play a videogame. In examples, an autonomous agent may be used to perform at least a portion of the input the user needs to provide. For example, an autonomous agent may assist a user when playing a videogame. Alternatively, in some examples, the autonomous agent may take control and perform the input the user needs to provide for a certain period of time. Alternatively, in some examples, once trained the autonomous agent may play the videogame independently.

Typically, an autonomous agent may be trained in a manner as to try to maximize their performance in the videogame. For example, the autonomous agent may be trained in order to maximize some reward from in-game events. For example, an autonomous agent may be trained to maximize health, points, attributes or the like within the videogame.

However, it can be difficult to train the autonomous agent. In particular, it can be difficult to easily and efficiently train the autonomous agent to act in a manner which conveys human-like behavior.

For example, an autonomous agent with an aim of maximizing rewards from in-game events may act in a way which is very different from a human player. Therefore, potential uses of autonomous agents may be restricted (particularly when it is required that the autonomous agent controls the software (such as a videogame) in a manner similar to the human).

Therefore, for at least these reasons, in addition to the reasons provided in the Background, it is desired that a more efficient manner of training an autonomous agent is provided.

Accordingly, a method, computer program and apparatus for training an autonomous agent are provided in accordance with embodiments of the disclosure.

### <Apparatus>

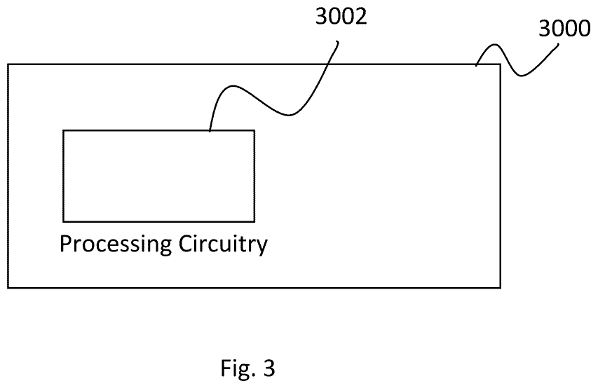

FIG. 3 of the present disclosure illustrates an apparatus in accordance with embodiments of the present disclosure.

The apparatus 3000 illustrated in FIG. 3 of the present disclosure comprises circuitry (processing circuitry) 3002. The circuitry 3002 is configured to: provide videogame data generated by a human playing a videogame as input data to a training network for training an autonomous agent for playing the videogame; generate videogame data of the trained autonomous agent playing the videogame; provide the videogame data of the trained autonomous agent playing the videogame data to a discriminator of a generative adversarial network ‘GAN’, the discriminator of the GAN being trained to distinguish videogame data of a human playing the videogame and videogame data of an autonomous agent playing the videogame; generate a classification, by the discriminator of the GAN, of the output videogame data of the trained autonomous agent playing the videogame as human or agent; and update at least one of the training network and the discriminator of the GAN based on the classification generated by the discriminator of the GAN.

In this manner, the autonomous agent (such as an autonomous agent for playing a videogame) can be trained more easily and efficiently in a manner which conveys human-like behavior.

In examples, the videogame data generated by the human playing the videogame as input data may be data from a single user. In examples, the videogame data generated by the human playing the videogame as input data may be data from a plurality of different users. In examples, the videogame data generated by the human playing the videogame may include recordings of human players playing the videogame. In examples, video recordings of human players playing the videogame may include video images including first person view of the videogame and/or video images including a third person view of the videogame. Hence more generally, training data for training the training network may comprise video images of gameplay by one or more different users.

In some examples, the training network for training the autonomous agent may include a reinforcement learning network. In examples, the reinforcement learning network may be one or more of an inverse reinforcement learning network and/or an imitation learning network. Further details regarding the training network used to train the autonomous agent based on the videogame data generated by the human playing the videogame will be provided later in the disclosure.

In examples, the data of the trained autonomous agent playing the videogame may be of the same type and format as the data (used for training) which has been input to the training network. For example, the data of the trained autonomous agent playing the videogame may include video images of the autonomous agent playing the videogame and which may include a first-person view of the videogame and/or a third person view of the videogame. By providing the data of the trained autonomous agent playing the videogame in the same type and format as the data which has been input to the training network, it becomes easier to compare the gameplay of the autonomous agent to the gameplay of the human player.

In examples, the discriminator of the GAN may have been trained (e.g. using the GAN) in order to distinguish human and non-human gameplay (such as gameplay by an autonomous agent). For example, the discriminator of the GAN may be trained using recorded video of human gameplay and recorded video of non-human gameplay. In examples, the recorded video of the human gameplay and the recorded video of the non-human gameplay may be labelled in order to facilitate supervised training of the discriminator). Thus, once trained, the discriminator may be used in order to distinguish videogame data of a human playing the videogame and videogame data of a non-human (such as an autonomous agent) playing the videogame.

In some examples, the training network for training the autonomous agent may be initially trained so as to train the agent to play a game and generated video images of the gameplay by the agent may be input to the discriminator for thereby training the discriminator using the GAN. Alternatively or in addition, in some examples the discriminator (discriminator network) of the GAN may be initially trained using labelled training data to learn to classify one or more (or a sequence) of input video images as being one of human gameplay and non-human gameplay. The discriminator may be initially trained in this way, and then deployed for use with the training network to allow training in the adversarial manner. More generally, the discriminator network and the training networked compete with each other to each attempt to become better for their given task. That is, the discriminator network seeks to become a better discriminator (by accurately discriminating between human gameplay and non-human gameplay) and the training network seeks to provide an autonomous agent that is capable of fooling/tricking the discriminator by providing ever more human-like gameplay.

In examples, the classification generated by the discriminator may be a binary classification (i.e. an identification, by the discriminator, of the videogame data as human or non-human (being performed by an autonomous agent)). In this way, the videogame data of the autonomous agent trained by the training network is provided to the discriminator with the aim of the training network being to trick or fool the discriminator into classifying the videogame data of the autonomous agent as being classified as human gameplay.

Generally, if the discriminator repeatedly classifies the videogame data of the autonomous agent as being non-human gameplay then the autonomous agent should be updated in a way that the discriminator subsequently classifies subsequently generated videogame data of the autonomous agent as being human gameplay. Subsequent to this, once the videogame data of the autonomous agent is sufficiently human-like so as to trick or fool the discriminator into classifying the videogame data of the autonomous agent as human-gameplay, then the discriminator should be updated in a way that the discriminator subsequently classifies subsequently generated videogame data of the autonomous agent as being non-human gameplay. Training of the training network and the discriminator in such an adversarial manner can potentially allow the videogame data of the autonomous agent to converge towards more human like behavior. Such processing may be repeated in a looping fashion until a predetermined condition is met. A predetermined condition which may be used may comprise one or more from the list comprising: a predetermined number of iterations, an elapse of a predetermined period of time, reaching a certain point in a video game (e.g. an end of a level in a game being played), and/or reaching a certain performance metric for one or more of the training network and/or the discriminator (e.g. a threshold rate of success). In examples, updating of at least one of the training network and the discriminator of the GAN based on the classification generated by the discriminator of the GAN is performed in order to reward the successfully entity within the adversarial network. That is, in examples, the training network will be rewarded if it successfully fools the discriminator network, while the discriminator will be rewarded if it successfully classifies the data from the training network as non-human (autonomous agent) gameplay.

In examples, in response to generating a classification, by the discriminator of the GAN, of the output videogame data of the trained autonomous agent playing the videogame as human or agent, the step of updating at least one of the training network and the discriminator of the GAN based on the classification generated by the discriminator of the GAN may comprise one or more of:
i) providing a low reward to the training network in response to the discriminator of the GAN generating a correct classification (i.e. classifying the video game data of the agent as non-human);
ii) providing a high reward to the discriminator network in response to the discriminator of the GAN generating the correct classification
iii) providing a high reward to the training network in response to the discriminator of the GAN generating an incorrect classification (i.e. classifying the video game data of the agent as human); and/or
iv) providing a low reward to the discriminator network in response to the discriminator of the GAN generating an incorrect classification (i.e. classifying the video game data of the agent as human).

In the above discussion, the terms low reward and high reward are relative. Generally, a high reward increases a likelihood that a same action will be taken by a network (training network and/or discriminator network) when presented with a same state/set of states (e.g., the training network will make a same decision in the future when faced with a same set of states for the video game). Conversely, a low reward decreases a likelihood that a same action will be taken by a network when presented with a same state/set of states. Therefore, a high reward can be provided to reward a behavior, and a low reward can be provided to discourage and/or penalize a behavior. In examples, a low reward can include a negative reward or penalty against a certain action. In examples, the low reward discourages an action because that action has a lower likelihood relative to an action with a higher reward.

The present disclosure is not particularly limited to the specific configuration of the apparatus as described with reference to FIG. 3 of the present disclosure. The apparatus 3000 may for example be provided as part of any of one or more of a server device and a user device. In some examples, the functionality of the apparatus 3000 may be performed in a distributed manner using two or more respective processing devices. Moreover, the functionality of the apparatus 3000 may be performed by a number of discrete processing nodes (processing units). Hence more generally, the circuitry 3002 may in some cases be implemented in a distributed fashion using one or more (e.g. a plurality) of processing devices operable to communicate with each other via one or more wired and/or wireless networks.

Hence more generally, when the discriminator of the GAN generates a correct classification, some methods may comprise updating one or more parameters of the training network so as to modify the training network to improve likelihood of subsequently fooling the discriminator. Alternatively or in addition, when the discriminator generates an incorrect classification, some methods may comprise adjusting one or more parameters of the discriminator of the GAN so as to modify the discriminator to improve likelihood of generating a correct classification for next videogame data of the trained autonomous agent playing the videogame.

Further details of the embodiments of the disclosure will now be provided.

### <Supervised Learning>

In an example embodiment of the present invention, the methods and techniques herein may at least partly be implemented using a supervised machine learning model.

The supervised learning model is trained using labelled training data to learn a function that maps inputs (typically provided as feature vectors) to outputs (i.e. labels). The labelled training data comprises pairs of inputs and corresponding output labels. The output labels are typically provided by an operator to indicate the desired output for each input. The supervised learning model processes the training data to produce an inferred function that can be used to map new (i.e. unseen) inputs to a label.

The input data (during training and/or inference) may comprise various types of data, such as numerical values, images, video, text, or audio. Raw input data may be pre-processed to obtain an appropriate feature vector used as input to the model—for example, features of an image or audio input may be extracted to obtain a corresponding feature vector. It will be appreciated that the type of input data and techniques for pre-processing of the data (if required) may be selected based on the specific task the supervised learning model is used for.

Once prepared, the labelled training data set is used to train the supervised learning model. During training the model adjusts its internal parameters (e.g. weights) so as to optimize (e.g. minimize) an error function, aiming to minimize the discrepancy between the model's predicted outputs and the labels provided as part of the training data. In some cases, the error function may include a regularization penalty to reduce overfitting of the model to the training data set.

The supervised learning model may use one or more machine learning algorithms in order to learn a mapping between its inputs and outputs. Example suitable learning algorithms include linear regression, logistic regression, artificial neural networks, decision trees, support vector machines (SVM), random forests, and the K-nearest neighbor algorithm.

Once trained, the supervised learning model may be used for inference—i.e. for predicting outputs for previously unseen input data. The supervised learning model may perform classification and/or regression tasks. In a classification task, the supervised learning model predicts discrete class labels for input data, and/or assigns the input data into predetermined categories. In a regression task, the supervised learning model predicts labels that are continuous values.

In some cases, limited amounts of labelled data may be available for training of the model (e.g. because labelling of the data is expensive or impractical). In such cases, the supervised learning model may be extended to further use unlabeled data and/or to generate labelled data.

Considering using unlabeled data, the training data may comprise both labelled and unlabeled training data, and semi-supervised learning may be used to learn a mapping between the model's inputs and outputs. For example, a graph-based method such as Laplacian regularization may be used to extend a SVM algorithm to Laplacian SVM in order to perform semi-supervised learning on the partially labelled training data.

Considering generating labelled data, an active learning model may be used in which the model actively queries an information source (such as a user, or operator) to label data points with the desired outputs. Labels are typically requested for only a subset of the training data set thus reducing the amount of labelling required as compared to fully supervised learning. The model may choose the examples for which labels are requested—for example, the model may request labels for data points that would most change the current model, or that would most reduce the model's generalization error. Semi-supervised learning algorithms may then be used to train the model based on the partially labelled data set.

### <Generative AI>

As explained, one or more example embodiments of the present invention may use generative artificial intelligence (AI) systems and techniques.

A generative AI system learns patterns and structures in its input training data, in order to then generate new output data which exhibits similar characteristics to the training data. Each of the input training data and output data may comprise various types of data, such as images, video, text, or audio. For example, the generative AI system may learn patterns in input training images, and then generate images that have similar characteristics.

The generative AI system may generate output data based on an input prompt. Like the training and output data, the prompt may comprise various types of data, such as images, video, text, or audio. The prompt may be of the same or different data type to the model's training and/or output data. For example, the input prompt may comprise text and the output data may comprise an image (e.g. matching an input text description of a desired image), or the input prompt may comprise an image and the output data may comprise audio data (e.g. with a theme matching the input image).

The generative AI system may comprise a generative model trained to learn a probability distribution of the input training data and generate new output data based on this learned distribution. For example, for a set of data instances/observable variables (X) and a set of labels/target variables (Y) in the training data set, the generative model may learn a joint probability distribution of data instances and labels p(X,Y), and/or a probability distribution of the data instances p(X) (for example where no labels are available).

Example suitable generative models for learning a probability distribution of the input training data include Variational Autoencoders (VAEs), transformer-based models, diffusion models (e.g. denoising diffusion probabilistic models (DDPMs)), Reinforcement Learning (RL), and Generative Adversarial Networks (GANs). The choice of generative model may depend on the specific task performed by the generative AI system.

The generative model may comprise one or more artificial neural networks. For example, a Variational Autoencoder (VAE) may comprise a pair of neural networks acting as an encoder and a decoder to and from a reduced (i.e. latent space) representation of the training data respectively, and a Generative Adversarial Network (GAN) may comprise a first ‘generator’ neural network that generates new data and a second ‘discriminator’ neural network that learns to discriminate between generated data and real data. The one or more constituent neural networks of the generative model may be trained together or separately.

During training, the generative model may adjust its internal parameters (e.g. neural network weights) so as to optimize (e.g. minimize) a loss/error function, aiming to minimize discrepancy between the generated output data and desired output data. It will be appreciated that the specific loss function, and algorithm used to optimize the function may vary depending on the nature of the generative model, and its intended application. For example, a mean squared error loss function may be used for an image generation task, and a cross-entropy loss function may be used for a text generation task. These loss functions may be optimized using various existing optimization algorithms, such as gradient descent.

Once trained, the generative model may be used to generate new output data based on an input prompt. The input prompt may be provided by a user, or by an appropriate device (e.g. using an application programming interface (API)).

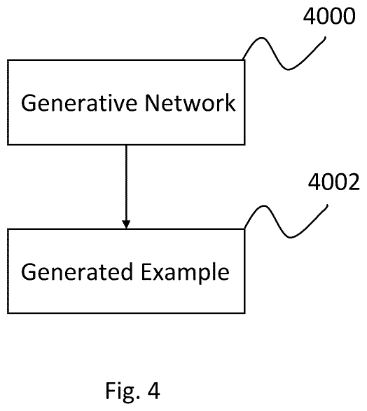

FIG. 4 illustrates an example of a generative network in accordance with embodiments of the disclosure.

The generative network 4000 of FIG. 4 is an example of a generative AI system which may generate output data based on a prompt. In this example, the generative network 4000 receives input data (such as an image, metadata or the like) and processes this input data to generate new output data based on the input data. In this example, the generative network 4000 generates a generated example 4002 based on the input data. The generated example is synthetic data which fits the distribution of the input data.

Thus, the generative AI system allows generating new content (e.g. images, text, or audio) based on only a prompt and without requiring detailed instructions for doing so.

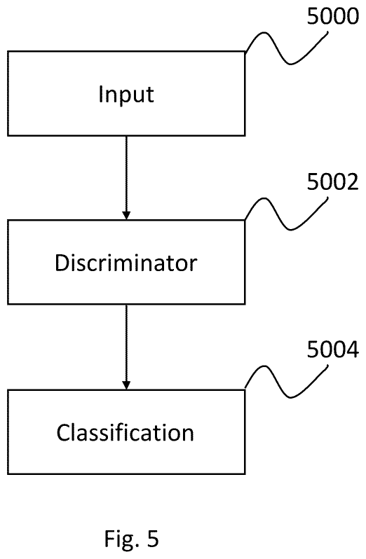

FIG. 5 of the present disclosure illustrates an example of a discriminator in accordance with embodiments of the disclosure. The discriminator may be used in a GAN with the generative network 4000.

The discriminator 5002 of FIG. 5 of the present disclosure takes an input 5000. The discriminator is trained to identify whether the input is real input (from an input domain) or fake/synthetic data (having been generated by a generative network such as that described with reference to FIG. 4 of the present disclosure). The output 5004 of the discriminator is therefore a classification of the data as real or fake (i.e. a binary classification of the data). In this way, the discriminator can be used to discriminate between real and fake data (for the data upon which the discriminator has been trained).

In the present disclosure, the discriminator 5000 is trained to discriminate between gameplay video of human players and trained autonomous agents. Therefore, the input 5002 to the discriminator 5000 is gameplay video of a videogame. The output is therefore a classification of this input video as human gameplay (being generated by a human playing the videogame) or autonomous gameplay (being generated by a trained autonomous agent playing the video game).

In examples, the generative network 4000 and the discriminator 5000 may be trained together. In this situation, the discriminator and the generative network compete against each other in an adversarial manner.

The generative network is used to generate new examples based on input data, while the discriminator is used in order to identify whether or not the data is real (from the input domain) or fake (generated by the generative model). Generally, when the discriminator successfully identifies a real or a fake input, no change is made to the parameters of the discriminator. Instead, one or more updates are made to the generative network's parameters. However, when the discriminator does not correctly identify the real or fake input, no change is made to the parameters of the generative network. Instead, one or more parameters of the discriminator are updated.

The training of the generative network and the discriminator may be continued for a predetermined time. Alternatively, the training of the generative network and the discriminator may be continued until the discriminator reaches a certain threshold of accuracy when classifying input data as real or fake (i.e. from the input domain or from the generative network). In examples, the training of the generative network may be continued until the discriminator cannot discriminate between data from the input domain (real data) and data generated by the generative network (synthetic data). In examples, once trained, the discriminator of the GAN may be used in an adversarial network with the training network in order to discriminate between human gameplay and gameplay of an autonomous agent trained by the training network. In other words, in examples, the adversarial loop (comprising the discriminator) sits on top of the main training loop for the autonomous agent, with the loss from the adversarial network being passed back to the training network (if the discriminator successfully classifies the gameplay from the autonomous agent).

Thus, in embodiments of the disclosure, a method of training a generative adversarial network is provided, the method comprising providing videogame data generated by a human playing a videogame as input data to a generative network of a trained generative adversarial network; generating by the generative network of the generative adversarial network, output videogame data of an autonomous agent playing the videogame; wherein the generative network of the generative adversarial network was trained using input data comprising videogame data generated by a human playing the videogame and a discriminator of the generative adversarial network was trained to distinguish videogame data of a human playing the videogame and videogame data of an autonomous agent playing the videogame.

### <Reinforcement Learning>

One or more example embodiments of the present invention may use reinforcement learning (RL) systems and techniques. In the present disclosure, reinforcement learning systems and techniques may be referred to as reinforcement learning models. In examples, reinforcement learning models may be used for training of the autonomous agent (i.e. as the training network of the present disclosure).

Reinforcement learning is a type of machine learning directed to training an artificial intelligence agent to take actions in an environment that maximize the notion of a cumulative reward. During reinforcement learning, the agent interacts with the environment, and learns from the results of its actions, thus allowing the agent to progressively improve its decision-making.

A reinforcement learning model can therefore be used in order to train an autonomous agent (e.g. to train an autonomous agent to play a videogame).

An RL model typically comprises an action-reward feedback loop. The feedback loop comprises: an environment, state, agent, policy, action, and reward. The environment is the system with which the agent interacts and in which the agent operates—for example, the environment may be a virtual environment of a game. The state represents the current conditions in the environment. The agent receives the state as an input and takes an action which may affect the environment and change the state of the environment. The agent takes the action based on its policy which is a mapping from states of the environment to actions of the agent. The policy may be deterministic or stochastic. The reward represents feedback from the environment to the action taken by the agent. The reward provides an indication (typically in the form of a numerical value) of the desirability of the result of the agent's action. The reward may comprise positive signals to reward desirable behavior of the agent and/or negative signals to penalize undesirable behavior of the agent.

Through multiple iterations of action-reward feedback loop, the agent aims to maximize the total cumulative reward it receives, thus learning how to take optimal actions in the environment. The reinforcement learning process thus allows the agent to learn an optimal policy that maximizes the cumulative reward. The cumulative award may be estimated using a value function which estimates the expected return starting from a given state or from a given state and action. Using the cumulative reward in the reinforcement learning process allows the agent to consider long-term effects of its policy.

A reinforcement learning algorithm may be used to refine the agent's policy and the value function over iterations of the action-reward feedback loop. The learning algorithm may rely on a model of the environment (e.g. based on Markov Decision Processes (MDPs)) or be model-free. Example suitable model-free reinforcement learning algorithms include Q-learning, SARSA (State-Action-Reward-State-Action), Deep Q-Networks (DQNs), or Deep Deterministic Policy Gradient (DDPG).

It will be appreciated that the agent will typically engage in both exploration and exploitation of the environment in which it operates. In exploration, the agent takes typically random actions to gather information about the environment and identify potentially desirable actions (i.e. actions that maximize cumulative reward). In exploitation, the agent takes actions that are expected to maximize reward (e.g. by selecting the action based on the agent's latest policy). Various techniques may be used to control the proportion of explorative and exploitative actions taken by the agent—for example, a predetermined probability of taking an explorative action in a given iteration of the feedback loop may be set (and optionally reduced over time to allow the agent to shifts more towards exploitation over time to maximize cumulative reward in view of diminishing returns for further exploration).

Thus, a reinforcement learning model can be used as an example of a training network configured to train an autonomous agent (e.g. as an autonomous agent to play a videogame).

Reinforcement learning models try to maximize the performance of agents in a game, based on some reward (e.g. from in-game events, for example). However, these reinforcement learning models do not consider the humanness of the actions of their agents; instead, they merely aim to maximize the performance of the agent in the game. As such, the use of autonomous agents in situations where replication of human-like behavior is required is particularly limited and difficult to achieve.

In some cases, a RL model may be configured to learn from feedback provided by a user. Utilizing user feedback in this way may allow the agent to improve its choice of actions and better align with user preferences. For example, reinforcement learning from human feedback (RLHF) techniques may be used. RLHF includes training a reward model based on user feedback and using this model for determining the reward in the reinforcement learning process described above. The user feedback may be received in various forms depending on the specific reinforcement learning problem being solved—for example, the feedback may be received in the form of a user ranking of instances of the agent's actions. RLHF thus allows incorporating user feedback into the reinforcement learning process. RLHF approaches may be advantageous where it is easier for a user than for an algorithm to assess the quality of the machine learning model's output (e.g. for generative artificial intelligence RL models).

While reinforcement learning from human feedback can be used to better align the choice of actions by an agent with user preferences, this does not ensure that the behavior of the agent will be human-like. That is, even if the agent has the same preference as a human, it may undertake actions to meet those goals in a manner very different than that would be taken by a human. Furthermore, reinforcement learning from human feedback is not an efficient way of training, as it requires feedback to be provided by the user.

Therefore, as noted in the background, it can be very difficult to efficiently generate autonomous agents which convey human-like behavior.

In the present disclosure, a discriminator (such as the discriminator described with reference to FIG. 5 of the present disclosure) can be combined with a training network in an adversarial manner when training autonomous agents. This can improve the efficiency of training using the training network. For example, a discriminator trained to discriminate between human and autonomous agent gameplay (or videogame data) can be used during the training of machine learning agents, in order that the agents learn to act more ‘human’. That is, the use of a discriminator when training machine learning agents in an adversarial manner enables the training network to act in a more human way.

In other words, the adversarial loop (comprising the discriminator) sits on top of the main training loop (comprising the training network). The adversarial network will then reward the training network when it successfully fools the discriminator but will pass the loss back to the training network (when the agent trained by the training network does not fool the discriminator).

Accordingly, the adversarial network will reward the training network for producing “human” like agents (i.e. agents which convey a human-like behavior) and will provide a lower reward for less “human” like agents.

This provides a very efficient way of training an autonomous agent to act in a manner which conveys human-like behavior.

The training network of the present disclosure is not particularly limited to reinforcement learning models. In examples, the training network may include inverse reinforcement learning models. In examples, the training network may include imitation learning models. In examples, a number of different models (such as a combination of reinforcement learning, inverse reinforcement learning and/or imitation learning models, for example) may be used when training the autonomous agent.

### Example Implementation

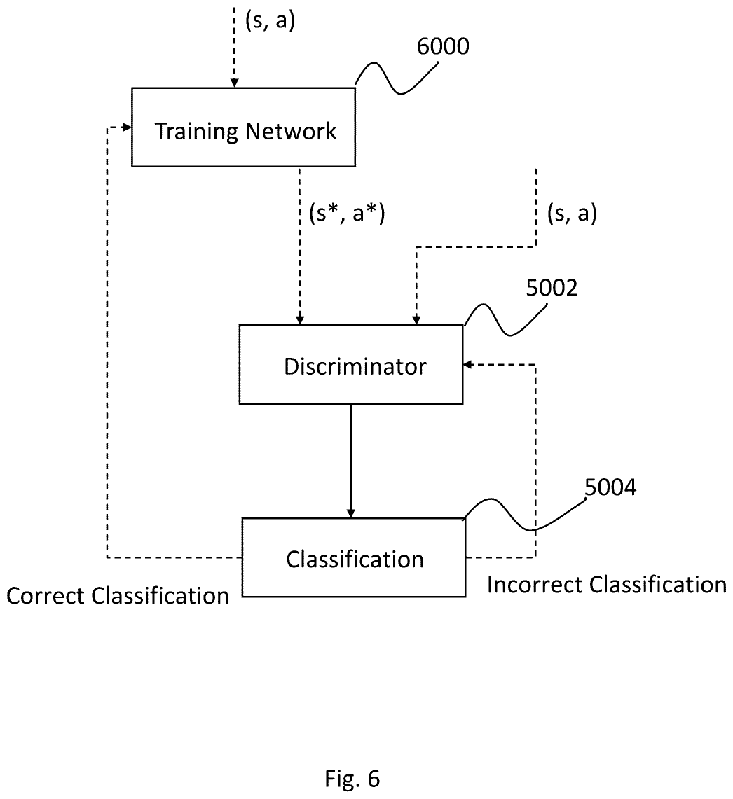

Turning to FIG. 6 of the present disclosure, an example implementation of an apparatus for training an autonomous agent is provided in accordance with embodiments of the disclosure.

The apparatus comprises a training network 6000 and a discriminator 5002. The training network and the discriminator operate in an adversarial manner (with training network sitting inside the adversarial loop) thus enabling an autonomous agent which can act in a manner which conveys human-like behavior to be easily and efficiently trained.

Consider, first, the training network 6000. The training network of FIG. 6 of the present disclosure is a network which can be used for training of an autonomous agent. In examples, the training network may include a reinforcement learning model. In examples, the reinforcement learning model may include one or more of an inverse reinforcement learning model and/or an imitation learning model.

During training of the autonomous agent, the training network receives videogame data generated by a human playing a videogame as input data. In examples, the input data may comprise image data(s) and actions (a).

The image data may be images comprising a recording of the human playing the videogame. In examples, the images may be still images (such as image frames). In examples, the images may be—or form a part—of a video sequence. In examples, the images may comprise a first person and/or third person view of the video game environment. A first-person view enables the training network to understand how the camera (or viewpoint) within the virtual environment is moving. A third person view may enable the training network to determine the world-movement of the character of the person within the videogame.

The action data (a) may comprise data concerning actions taken by the character controlled by the human during the video game (e.g. a jump, a run, a kick, a punch, a change of vehicle, or the like). The action data may comprise data such as a control instruction (or input) provided by the human (e.g. a button press, operation of a joystick, a gesture, a voice instruction or the like).

The action data and the image data may be synchronized.

The training network is configured to train the autonomous agent based on the input data. In effect, the training network observes the human playing the videogame and aims to provide autonomous agent which will be able to autonomously control the videogame to achieve the same goals as observed for the human player (from the input data).

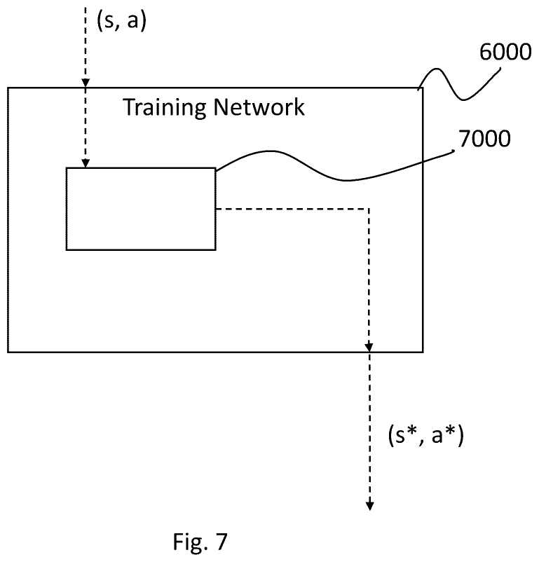

A more detailed illustration of a training network is shown in FIG. 7 of the present disclosure. That is, FIG. 7 illustrates an example of a training network in accordance with embodiments of the disclosure.

As explained with reference to FIG. 6 of the present disclosure, the training network 6000 receives input data (s, a). This is an example of videogame data generated by a human playing a videogame. A training model 7000 then trains an autonomous agent based on this input data. Once trained, the autonomous agent is then used to generate videogame data of the autonomous agent playing the videogame. In examples, a recording of the autonomous agent playing the videogame could be made. In examples, the videogame data of the autonomous agent playing the videogame comprises image data (s*) and action data (a*). The image data (s*) and the action data (a*) may be of the same type as the data (s, a). Therefore, further details will not be provided for brevity of disclosure.

As explained the training model 7000 may comprise one or more of an inverse reinforcement learning model and/or an imitation learning model.

The inverse reinforcement learning model aims to learn the reward function of an agent, given the observed behavior (here, the human videogame data). Any suitable inverse reinforcement learning model known in the art may be applied as the training model 7000 in accordance with the present disclosure.

For an inverse reinforcement learning model, the model (described with reference to FIG. 6) operates concurrently with the training of the autonomous agent. That is, as the inverse reinforcement learning model is trained, using the human data, samples of images (s*) and actions (a*) of the autonomous agent playing the videogame are continuously generated. Therefore, at each iteration it is possible to provide training in the adversarial loop (as described with reference to FIG. 6) by comparing the real human data that the autonomous agent is trained on with the fake samples it has generated (the data of the autonomous agent playing the videogame) during interaction with the environment.

Thus, when the training model comprises or is an inverse reinforcement learning model, the method comprises iteratively training the autonomous agent using the inverse reinforcement learning network on the videogame data generated by the human playing the videogame; and generating the output videogame data of the trained autonomous agent playing the videogame after each training iteration.

For the imitation learning model, it is possible to operate the training network in a staggered fashion with the adversarial loop (as described with reference to FIG. 6 of the present disclosure). That is, the training model 7000 of the training network 6000 is first trained on the dataset (s,a). Then, after a number of epochs (once the autonomous agent has been trained on a given portion of the training data, for example) the trained autonomous agent may then be deployed in the environment (i.e. the videogame) to collect the data of the autonomous agent playing the videogame (i.e. s* and a*). After this data has been generated, it is possible to provide training in the adversarial loop (as described with reference to FIG. 6) by comparing real human data that the autonomous agent is trained on with the fake samples it has generated (the data of the autonomous agent playing the videogame) during interaction with the environment.

Thus, when the training network comprises or is an imitation learning network, the method comprises training the autonomous agent using the imitation learning network on the videogame data generated by the human playing the videogame for a predetermined number of epochs; and generating the output videogame data of the trained autonomous agent playing the videogame after the predetermined number of epochs.

In this way, the training network generates the videogame data of the autonomous agent playing the videogame.

Furthermore, in some examples, the training network may be a network which trains the autonomous agent without receiving input from a human playing a video game. For example, the training network may be a reinforcement learning type training network as has been previously described. However, it may be desirable (for reasons previously discussed herein) that the training network trains the autonomous agent in a way which produces an autonomous agent which has a similar style to a human player. Therefore, even when the autonomous agent is trained without input training data of a human playing the video game, embodiments of the disclosure (such as the adversarial network of FIG. 6) can be used in order to reward the training network for producing “human” like agents (and provide a lower reward for the training network when producing less “human” like agents). This is achieved using the discriminator within the adversarial network (described in more detail below).

Hence, embodiments of the disclosure provide a method of training an autonomous agent, the method comprising: generating videogame data of a trained autonomous agent playing a videogame; providing the videogame data of the trained autonomous agent playing the videogame data to a discriminator of a generative adversarial network ‘GAN’, the discriminator of the GAN being trained to distinguish videogame data of a human playing the videogame and videogame data of an autonomous agent playing the videogame; generating a classification, by the discriminator of the GAN, of the output videogame data of the trained autonomous agent playing the videogame as human or agent; and updating at least one of the training network and the discriminator of the GAN based on the classification generated by the discriminator of the GAN.

Returning to FIG. 6 of the present disclosure, the adversarial loop (adversarial network) is described again in more detail.

Once the training network 6000 has performed training of the autonomous agent on the input data and generated videogame data of the trained autonomous agent playing the videogame, this videogame data is then provided to the discriminator (which will then attempt to classify the videogame data as being produced by a human or an autonomous agent).

Indeed, as illustrated in FIG. 6, the trained discriminator (having been trained in a GAN) is able to receive two inputs. The first of these two inputs is the videogame data of the (trained) autonomous agent playing the videogame. The second of these two inputs is data of the human playing the videogame (s, a). In examples, the second input (s, a) may comprise the same data as the data (s, a) which was used as an input to the training network. In examples, the second input (s, a) may comprise different videogame data of a human playing the videogame.

The discriminator 5002 can thus be configured to receive data (s*, a*) and/or data (s, a) as input. The discriminator 5002 then generates a classification 5004, with the classification comprising an identification of the data as either being a real sample (i.e. of the human playing the videogame) or a fake sample (i.e. of an autonomous agent playing the videogame).

Once the discriminator 5002 has generated this classification 5004, the classification is reviewed in order to check whether or not the discriminator 5002 has produced a correct classification of the data.

In the event of a correct classification, the training network has failed to fool the discriminator 5002; that is, the discriminator was able to recognize that the autonomous agent was playing the videogame. Thus, the autonomous agent was not human-like enough to fool the discriminator. Accordingly, one or more of the parameters of the training network can be adjusted responsive to this. In examples, a low reward may be provided to the training network in response to the training network generating an agent which was not “human” enough to fool the discriminator. On the other hand, when the discriminator was not able to recognize that the autonomous agent was playing the videogame (i.e. an incorrect classification) one or more of the parameters of the discriminator may be adjusted (in order to make the discriminator better at discriminating between human and autonomous agent videogame data). In some examples, an adjustment to both the training network and the discriminator may be performed in response to a correct classification (or an incorrect classification). Thus, the training network and the discriminator operate in an adversarial manner.

In examples, the process described with reference to FIG. 6 of the present disclosure may be repeated until the classification generated by the discriminator satisfies a predetermined condition. In examples, the predetermined condition may be that the discriminator generates a correct classification with an accuracy less than a predetermined threshold (such that the discriminator can no longer discriminate between the videogame data of the human playing the videogame and the videogame data of the autonomous agent playing the videogame). The predetermined threshold level of the discriminator in discriminating between the human and non-human (autonomous agent) gameplay is not particularly limited and may depend on the situation to which the techniques of the disclosure are applied. However, in a limit, the discriminator may identify the data as human (or autonomous agent) 50% of the time, thus indicating that the discriminator is unable to discriminate between the human and non-human (autonomous agent) videogame data.

Thus, training the adversarial network (or adversarial loop) can be used over the course of the main agent training (by the training network), with the adversarial network providing constant feedback to the training network on how close the “fake” data (the videogame data of the autonomous agent playing the videogame) is to the “real” data (the videogame data of the human playing the videogame).

The agent can be rewarded (high reward) for fooling the discriminator network, and the discriminator network can be rewarded if not fooled. Alternatively or in addition, one or more of the agent and the discriminator network may be provided with a low reward, as discussed previously. This adversarial loop sits on top of the training loop for the agent, with the loss from the adversarial network being passed back to the training network. The adversarial network will generally reward the training network for producing “human” like agents, with a lower reward for less “human” like agents.

In this way, the discriminator acts as a filter for “out of distribution” examples in gameplay datasets, so as to help training. This enables an autonomous agent which can act in a manner which conveys human-like behavior to be easily and efficiently trained.

In some examples, the generative adversarial network may for example use Deep Convolutional Generative Adversarial Network (DCGAN) with convolutional networks in the generative network (training network) and discriminator network.

As such, the example apparatus of FIG. 6 is an example of an apparatus for training an autonomous agent, the apparatus comprising circuitry configured to: provide videogame data generated by a human playing a videogame as input data to a training network for training an autonomous agent for playing the videogame; generate videogame data of the trained autonomous agent playing the videogame; provide the videogame data of the trained autonomous agent playing the videogame data to a discriminator of a generative adversarial network ‘GAN’, the discriminator of the GAN being trained to distinguish videogame data of a human playing the videogame and videogame data of an autonomous agent playing the videogame; generate a classification, by the discriminator of the GAN, of the output videogame data of the trained autonomous agent playing the videogame as human or agent; and update at least one of the training network and the discriminator of the GAN based on the classification generated by the discriminator of the GAN.

### <Method>

Hence, more generally, a method of training an autonomous agent is provided in accordance with embodiments of the disclosure.

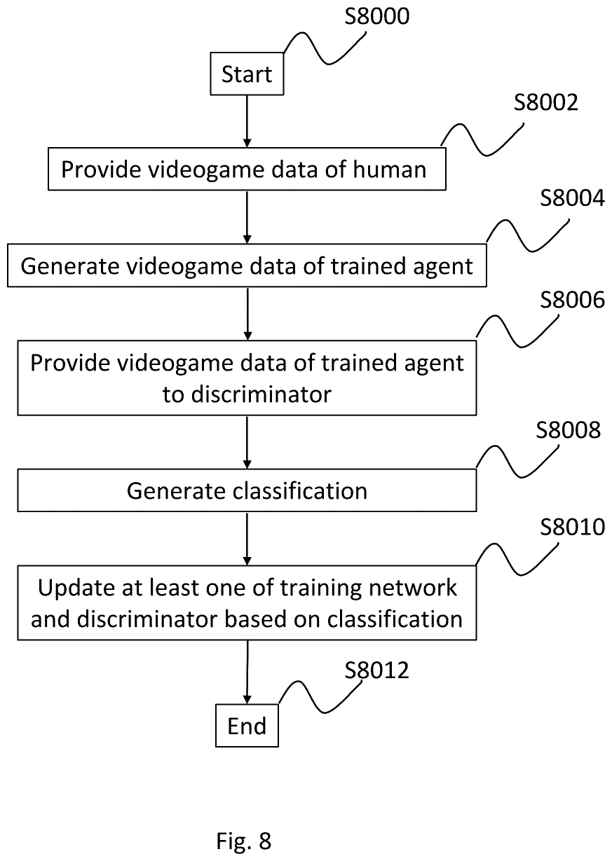

FIG. 8 illustrates a method of the present disclosure. The method of FIG. 8 may be a computer implemented method. In examples, the method of FIG. 8 may be executed by an apparatus as described with reference to FIG. 1 of the present disclosure or an entertainment system as described with reference to FIG. 2 of the present disclosure, for example.

The method of FIG. 8 starts at step S8000 and proceeds to step S8002.

In step S8002, the method comprises providing videogame data generated by a human playing a videogame as input data to a training network for training an autonomous agent for playing the videogame.

In step S8004, the method comprises generating videogame data of the trained autonomous agent playing the videogame.

Then, in step S8006, the method comprises providing the videogame data of the trained autonomous agent playing the videogame data to a discriminator of a generative adversarial network ‘GAN’, the discriminator of the GAN being trained to distinguish videogame data of a human playing the videogame and videogame data of an autonomous agent playing the videogame.

In step S8008, the method comprises generating a classification, by the discriminator of the GAN, of the output videogame data of the trained autonomous agent playing the videogame as human or agent.

Step S8010 comprises updating at least one of the training network and the discriminator of the GAN based on the classification generated by the discriminator of the GAN.

The method then proceeds to and ends with step S8012.

### <Computer Program>

Furthermore, it will be appreciated that the methods of the present disclosure may be carried out on conventional hardware (such as that described previously herein) suitably adapted as applicable by software instruction or by the inclusion or substitution of dedicated hardware. Thus, the required adaptation to existing parts of a conventional equivalent device may be implemented in the form of a computer program product comprising processor implementable instructions stored on a non-transitory machine-readable medium such as a floppy disk, optical disk, hard disk, PROM, RAM, flash memory or any combination of these or other storage media, or realized in hardware as an ASIC (application specific integrated circuit) or an FPGA (field programmable gate array) or other configurable circuit suitable to use in adapting the conventional equivalent device. Separately, such a computer program may be transmitted via data signals on a network such as an Ethernet, a wireless network, the Internet, or any combination of these or other networks.

### Clauses

In addition, embodiments of the present disclosure may be arranged in accordance with the following numbered clauses.

1) A method of training an autonomous agent, the method comprising:
providing videogame data generated by a human playing a videogame as input data to a training network for training an autonomous agent for playing the videogame;
generating videogame data of the trained autonomous agent playing the videogame;
providing the videogame data of the trained autonomous agent playing the videogame data to a discriminator of a generative adversarial network ‘GAN’, the discriminator of the GAN being trained to distinguish videogame data of a human playing the videogame and videogame data of an autonomous agent playing the videogame;
generating a classification, by the discriminator of the GAN, of the output videogame data of the trained autonomous agent playing the videogame as human or agent; and
updating at least one of the training network and the discriminator of the GAN based on the classification generated by the discriminator of the GAN.
   2) The method according to clause 1, wherein the method comprises repeating the steps of the method until the classification generated by the discriminator of the GAN satisfies a predetermined condition.
   3) The method according to clause 2, wherein the predetermined condition is that the discriminator of the GAN generates a correct classification with an accuracy of at least a predetermined threshold.
   4) The method according to any preceding clause, wherein the videogame data comprises image data of the videogame and action data of the videogame.
   5) The method according to clause 4, wherein the image data of the videogame comprises at least one of first-person video and third person video of the videogame.
   6) The method according to any preceding clause, wherein the training network comprises at least one of an inverse reinforcement learning network and an imitation learning network.
   7) The method according to clause 6, wherein when the training network comprises an inverse reinforcement learning network, the method comprises iteratively training the autonomous agent using the inverse reinforcement learning network on the videogame data generated by the human playing the videogame; and generating the output videogame data of the trained autonomous agent playing the videogame after each training iteration.
   8) The method according to clause 6, wherein when the training network comprises an imitation learning network, the method comprises training the autonomous agent using the imitation learning network on the videogame data generated by the human playing the videogame for a predetermined number of epochs; and generating the output videogame data of the trained autonomous agent playing the videogame after the predetermined number of epochs.
   9) The method according to any preceding clause, wherein when the discriminator of the GAN generates a correct classification, the method comprises adjusting one or more parameters of the training network by providing the training network with a low reward and/or adjusting one or more parameters of the discriminator of the GAN by providing the discriminator of the GAN with a high reward.
   10) The method according to any preceding clause, wherein when the discriminator generates an incorrect classification, the method comprises adjusting one or more parameters of the discriminator of the GAN by providing the discriminator of the GAN with a low reward and/or adjusting one or more parameters of the training network by providing the training network with a high reward.
   11) The method according to clause 9 or clause 10, wherein the low reward comprises a penalty.
   12) The method according to any preceding clause, wherein the videogame data generated by the human playing the videogame comprises data from a plurality of human players of the videogame.
   13) The method according to any preceding clause, comprising using the trained autonomous agent to play the videogame.
   14) A computer program comprising instructions which, when implemented by a computer, cause the computer to perform a method of training an autonomous agent, the method comprising:
providing videogame data generated by a human playing a videogame as input data to a training network for training an autonomous agent for playing the videogame;
generating videogame data of the trained autonomous agent playing the videogame;
providing the videogame data of the trained autonomous agent playing the videogame data to a discriminator of a generative adversarial network ‘GAN’, the discriminator of the GAN being trained to distinguish videogame data of a human playing the videogame and videogame data of an autonomous agent playing the videogame;
generating a classification, by the discriminator of the GAN, of the output videogame data of the trained autonomous agent playing the videogame as human or agent; and
updating at least one of the training network and the discriminator of the GAN based on the classification generated by the discriminator of the GAN.
   15) A non-transitory computer readable storage medium storing the computer program according to clause 14.
   16) An apparatus for training an autonomous agent, the apparatus comprising circuitry configured to:
provide videogame data generated by a human playing a videogame as input data to a training network for training an autonomous agent for playing the videogame;
generate videogame data of the trained autonomous agent playing the videogame;
provide the videogame data of the trained autonomous agent playing the videogame data to a discriminator of a generative adversarial network ‘GAN’, the discriminator of the GAN being trained to distinguish videogame data of a human playing the videogame and videogame data of an autonomous agent playing the videogame;
generate a classification, by the discriminator of the GAN, of the output videogame data of the trained autonomous agent playing the videogame as human or agent; and
update at least one of the training network and the discriminator of the GAN based on the classification generated by the discriminator of the GAN.

Furthermore, it will be appreciated that numerous modifications and variations of the present disclosure are possible in light of the above teachings. It is therefore to be understood that within the scope of the appended claims, the disclosure may be practiced otherwise than as specifically described herein.

In so far as embodiments of the disclosure have been described as being implemented, at least in part, by software-controlled data processing apparatus, it will be appreciated that a non-transitory machine-readable medium carrying such software, such as an optical disk, a magnetic disk, semiconductor memory or the like, is also considered to represent an embodiment of the present disclosure.

It will be appreciated that the above description for clarity has described embodiments with reference to different functional units, circuitry and/or processors. However, it will be apparent that any suitable distribution of functionality between different functional units, circuitry and/or processors may be used without detracting from the embodiments.

Described embodiments may be implemented in any suitable form including hardware, software, firmware or any combination of these. Described embodiments may optionally be implemented at least partly as computer software running on one or more data processors and/or digital signal processors. The elements and components of any embodiment may be physically, functionally and logically implemented in any suitable way. Indeed, the functionality may be implemented in a single unit, in a plurality of units or as part of other functional units. As such, the disclosed embodiments may be implemented in a single unit or may be physically and functionally distributed between different units, circuitry and/or processors.

Although the present disclosure has been described in connection with some embodiments, it is not intended to be limited to the specific form set forth herein. Additionally, although a feature may appear to be described in connection with particular embodiments, one skilled in the art would recognize that various features of the described embodiments may be combined in any manner suitable to implement the technique.

1. A method of training an autonomous agent, the method comprising:
providing videogame data generated by a human playing a videogame as input data to a training network for training an autonomous agent for playing the videogame;
generating videogame data of the trained autonomous agent playing the videogame;
providing the videogame data of the trained autonomous agent playing the videogame data to a discriminator of a generative adversarial network ‘GAN’, the discriminator of the GAN being trained to distinguish videogame data of a human playing the videogame and videogame data of an autonomous agent playing the videogame;
generating a classification, by the discriminator of the GAN, of the videogame data of the trained autonomous agent playing the videogame as human or agent; and
updating at least one of the training network and the discriminator of the GAN based on the classification generated by the discriminator of the GAN.

2. The method according to claim 1, wherein the method comprises repeating the steps of the method until the classification generated by the discriminator of the GAN satisfies a predetermined condition.

3. The method according to claim 2, wherein the predetermined condition is that the discriminator of the GAN generates a correct classification with an accuracy of at least a predetermined threshold.

4. The method according to claim 1, wherein the videogame data comprises image data of the videogame and action data of the videogame.

5. The method according to claim 4, wherein the image data of the videogame comprises at least one of first-person video and third person video of the videogame.

6. The method according to claim 1, wherein the training network comprises at least one of an inverse reinforcement learning network and an imitation learning network.

7. The method according to claim 6, wherein when the training network comprises an inverse reinforcement learning network, the method comprises iteratively training the autonomous agent using the inverse reinforcement learning network on the videogame data generated by the human playing the videogame; and generating the videogame data of the trained autonomous agent playing the videogame after each training iteration.

8. The method according to claim 6, wherein when the training network comprises an imitation learning network, the method comprises training the autonomous agent using the imitation learning network on the videogame data generated by the human playing the videogame for a predetermined number of epochs; and generating the videogame data of the trained autonomous agent playing the videogame after the predetermined number of epochs.

9. The method according to claim 1, wherein when the discriminator of the GAN generates a correct classification, the method comprises adjusting one or more parameters of the training network by providing the training network with a low reward and/or adjusting one or more parameters of the discriminator of the GAN by providing the discriminator of the GAN with a high reward.

10. The method according to claim 1, wherein when the discriminator generates an incorrect classification, the method comprises adjusting one or more parameters of the discriminator of the GAN by providing the discriminator of the GAN with a low reward and/or adjusting one or more parameters of the training network by providing the training network with a high reward.

11. The method according to claim 9, wherein the low reward comprises a penalty.

12. The method according to claim 1, wherein the videogame data generated by the human playing the videogame comprises data from a plurality of human players of the videogame.

13. The method according to claim 1, comprising using the trained autonomous agent to play the videogame.

14. A non-transitory computer readable medium comprising computer executable instructions adapted to cause a computer system to perform a method of training an autonomous agent, the method comprising:
providing videogame data generated by a human playing a videogame as input data to a training network for training an autonomous agent for playing the videogame;
generating videogame data of the trained autonomous agent playing the videogame;
providing the videogame data of the trained autonomous agent playing the videogame data to a discriminator of a generative adversarial network ‘GAN’, the discriminator of the GAN being trained to distinguish videogame data of a human playing the videogame and videogame data of an autonomous agent playing the videogame;
generating a classification, by the discriminator of the GAN, of the videogame data of the trained autonomous agent playing the videogame as human or agent; and
updating at least one of the training network and the discriminator of the GAN based on the classification generated by the discriminator of the GAN.

15. The non-transitory computer readable medium according to claim 14, wherein the method further comprises repeating the steps of the method until the classification generated by the discriminator of the GAN satisfies a predetermined condition.

16. The non-transitory computer readable medium according to claim 15, wherein the predetermined condition is that the discriminator of the GAN generates a correct classification with an accuracy of at least a predetermined threshold.

17. The non-transitory computer readable medium according to claim 14, wherein the videogame data comprises image data of the videogame and action data of the videogame.

18. An apparatus for training an autonomous agent, the apparatus comprising circuitry configured to perform operations comprising:
providing videogame data generated by a human playing a videogame as input data to a training network for training an autonomous agent for playing the videogame;
generating videogame data of the trained autonomous agent playing the videogame;
providing the videogame data of the trained autonomous agent playing the videogame data to a discriminator of a generative adversarial network ‘GAN’, the discriminator of the GAN being trained to distinguish videogame data of a human playing the videogame and videogame data of an autonomous agent playing the videogame;
generating a classification, by the discriminator of the GAN, of the videogame data of the trained autonomous agent playing the videogame as human or agent; and
updating at least one of the training network and the discriminator of the GAN based on the classification generated by the discriminator of the GAN.

19. The apparatus according to claim 18, wherein the circuitry is further configured to repeat the operations until the classification generated by the discriminator of the GAN satisfies a predetermined condition.

20. The apparatus according to claim 19, wherein the predetermined condition is that the discriminator of the GAN generates a correct classification with an accuracy of at least a predetermined threshold.
